(19) United States
(12) Patent Application Publication
(10) Pub. No.: US 2015/0078557 A1
(43) Pub. Date: Mar. 19, 2015

(54) AUDIO SYSTEM

(71) Applicant: JANKY TECHNOLOGY CO., LTD., Taichung City (TW)

(72) Inventor: Shih-Chun Li, Taichung City (TW)

(73) Assignee: JANKY TECHNOLOGY CO., LTD., Taichung City (TW)

(21) Appl. No.: 14/027,641

(22) Filed: Sep. 16, 2013

(51) Int. Cl. H04R 29/00; H04R 1/10

(52) U.S. Cl. CPC H04R 29/00; H04R 1/1041
USPC 381/58

(57) ABSTRACT

A wireless headset mode and audio mode selectable audio system includes a major audio device, a wireless audio device, and a wireless headset device. The major audio device includes an audio input selection unit, a digital signal processing unit, a speaker driving unit, a wireless transceving unit, a control unit, and a speaker. The wireless audio device includes a first wireless transceving unit, a first control unit, a first speaker driving unit, and a first speaker. The wireless headset device includes a second wireless transceving unit, a second speaker driving unit, a second control unit, and a second speaker. When the wireless headset is turned on, a signal will be sent to the major audio device to turn off the sound output of the speaker of the major audio device and the first speaker of the wireless audio device, thus entering a mute mode.

### BACKGROUND

1. Technical Field

The present invention provides an audio system, particularly to an audio system capable of selecting wireless headset mode or audio mode.

2. Related Art

Among all the audio systems, some use wireless audio unit to reduce the volume of the specific audio unit or achieve the multichannel sound effect. Besides, high-power or large audio system can provide large volume and high quality sound output for users to enjoy.

However, no matter large or small audio system, people can be disturbed when the aforementioned audio systems are in use, which can lead to inconvenience. Particularly, the large audio system can create large decibel sound which may influence the environment even more.

Although those problems mentioned above can be solved by using a wired headset, however, the wired headset can be restricted by the wire, which may cause inconvenience.

### BRIEF SUMMARY

The present invention provides an audio system with wireless headsets. The present invention also provides another audio system where the audio output therefrom is selectable between the wireless headset mode and the audio mode.

The present invention also provides another audio system, when the wireless headset of the audio system is turned on, the speaker of the audio device will change to mute mode.

The present invention also provides still another audio system, which uses different audio signal processing method for wireless headset mode and audio mode, thereby optimizing the outputted sound effect.

The technique used in the present invention as follows: The present invention provides an audio system, which includes a major audio device, a wireless audio device, and a wireless headset device. The major audio device includes an audio input selection unit, a digital signal processing unit, a speaker driving unit, a wireless transceving unit, a control unit, and a speaker. The major audio device is connected to all kinds of audio input, and the audio input selection unit is used to select an audio signal of the audio input. After being processed by the digital signal processing unit, the audio signal makes the speaker driving unit to drive the speaker, and the audio signal being selected is sent to the air via the wireless transceving unit. The control unit is used for calculating and processing the audio signal. The wireless audio device includes a first wireless transceving unit, a first control unit, a first speaker driving unit and a first speaker. The first wireless transceving unit receives a wireless signal sent from the major audio device, and further makes the first speaker driving unit to drive the first speaker to output the sound. The first control unit is used for calculating and processing the wireless signal. The wireless headset device includes a second wireless transceving unit, a second speaker driving unit, a second control unit, and a second speaker. The second transceving unit receives a wireless signal sent from the major audio device, and further makes the second speaker driving unit to drive the second speaker to output the sound. The second control unit is used for calculating and processing the wireless signal. When the wireless headset is turned on, a signal will be sent to the major audio device to turn off the audio output from the speaker of the major audio device and the first speaker of the wireless audio device, thus entering mute mode.

For the aforementioned audio system, when the wireless headset is turned on, a signal will be sent to the major audio device from the second wireless transceving unit after being processed by the second control unit. The wireless transceving unit of the major audio device receives the signal, and the signal is processed by the control unit to further drive the speaker driving unit to stop the audio output from the speaker. The wireless transceving unit sends a mute order signal to the wireless audio device. After the wireless audio device receives the mute order signal via the wireless transceving unit, the mute order signal is processed by the control unit to stop the audio output from the first speaker.

For the aforementioned audio system, when the wireless transceving unit of the major audio device receives the turn-on signal of the wireless headset, the control unit will inform the digital signal processing unit to alter the audio signal processing method to wireless headset mode, which improves the outputted sound quality of the headset.

For the aforementioned audio system, the headset mode uses a wireless headset algorithm.

For the aforementioned audio system, when the wireless headset is turned off, the second control unit orders the second wireless transceving unit to send a corresponding signal to the major audio device. After the wireless transceving unit of the major audio device receives the corresponding signal, the corresponding signal is processed by the control unit. The control unit informs the digital signal processing unit to alter the audio signal processing method to audio mode, and the wireless audio device is informed via the wireless transceving unit to improve the outputted sound quality of the audio device and the wireless audio device.

For the aforementioned audio system, the major audio device further includes an user interface for displaying and inputting information.

For the aforementioned audio system, the wireless headset device further includes an user interface for inputting information.

The advantage of the present invention is: By receiving and selecting all kinds of audio input with the major audio device, not only the major audio device can output sound, but also being able to send the sound to the wireless audio device and the wireless headset device via the wireless transceving unit. When the headset is in use, the user does not need to play the music via the major audio device and the wireless audio device. Therefore, when the headset is turned on, the audio system will automatically turns off the sound output of the major audio device and the wireless audio device. The wireless transceving units used in wireless headset device and the wireless audio device have a function of reciprocation, which can return the using status back to the major audio device. The major audio device can choose different audio processing modes based on different audio players, thereby achieving the best sound effect. Besides, by integrating the wireless headset and the wireless audio device, the audio system according to the present invention can share the circuits of input, audio processing, and wireless transceving unit, thereby reducing the cost of the audio system and minimizing the inconvenience of repeatedly reconnecting the audio signal between two audio playing devices. Moreover, by the integrated user interface, the switch between the two audio playing devices can be simplified as well.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a stereogram of a preferred embodiment of an audio system according to the present invention;

FIG. 2 is a schematic diagram of the preferred embodiment of the audio system according to the present invention;

FIG. 3 is a schematic diagram of the preferred embodiment of the audio system wherein a major audio device wiredly linked to an user interface according to the present invention; and

FIG. 4 is a schematic diagram of the preferred embodiment of the audio system wherein a major audio device wirelessly linked to an user interface according to the present invention.

### DETAILED DESCRIPTION

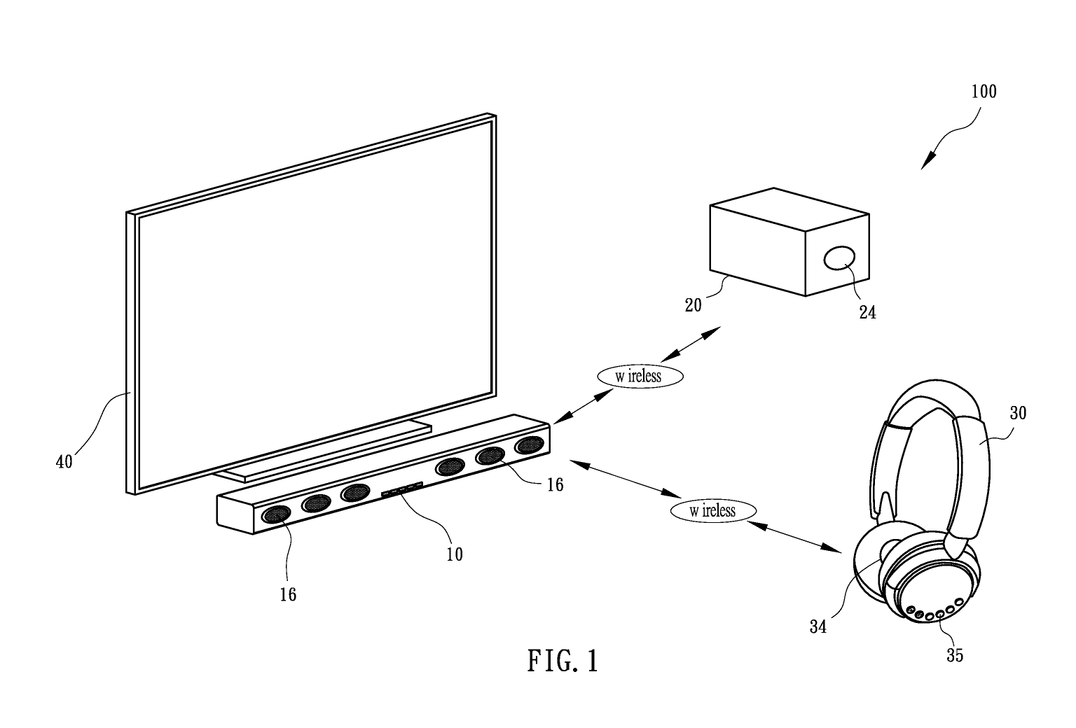

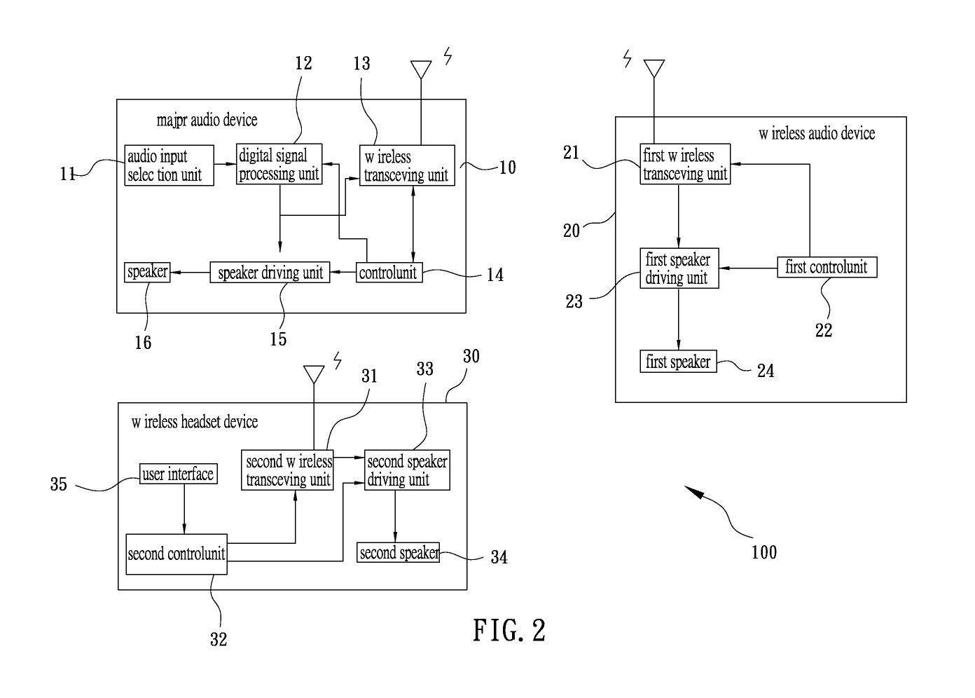

Referring to FIGS. 1 and 2, the audio system 100 according to the present invention includes a major audio device 10, a wireless audio device 20, and a wireless headset device 30.

Referring to FIG. 2, in a preferred embodiment according to the present invention, the major audio device 10 includes an audio input selection unit 11, a digital signal processing unit 12, a wireless transceving unit 13, a control unit 14, a speaker driving unit 15, and a speaker 16.

The major audio device 10 connects all kinds of audio input 40, such as a television, as shown in FIG. 1. The audio input selection unit 11 selects the audio input 40. After being processed by the digital signal processing unit 12, the audio input 40 informs the speaker driving unit 15 to drive the speaker 16 to generate sound. Moreover, the selected audio input 40 is sent to the air via the wireless transceving unit 13, and the control unit 14 is used for calculating and processing the audio input 40.

The aforementioned digital signal processing unit 12 mainly does sound effect processing, such as 3-D effect, high peach or low peach equalizer adjustment, etc. The digital signal processing unit 12 also provides algorithms, such as audio algorithm for using in audio mode, or wireless headset algorithm for using in headset mode.

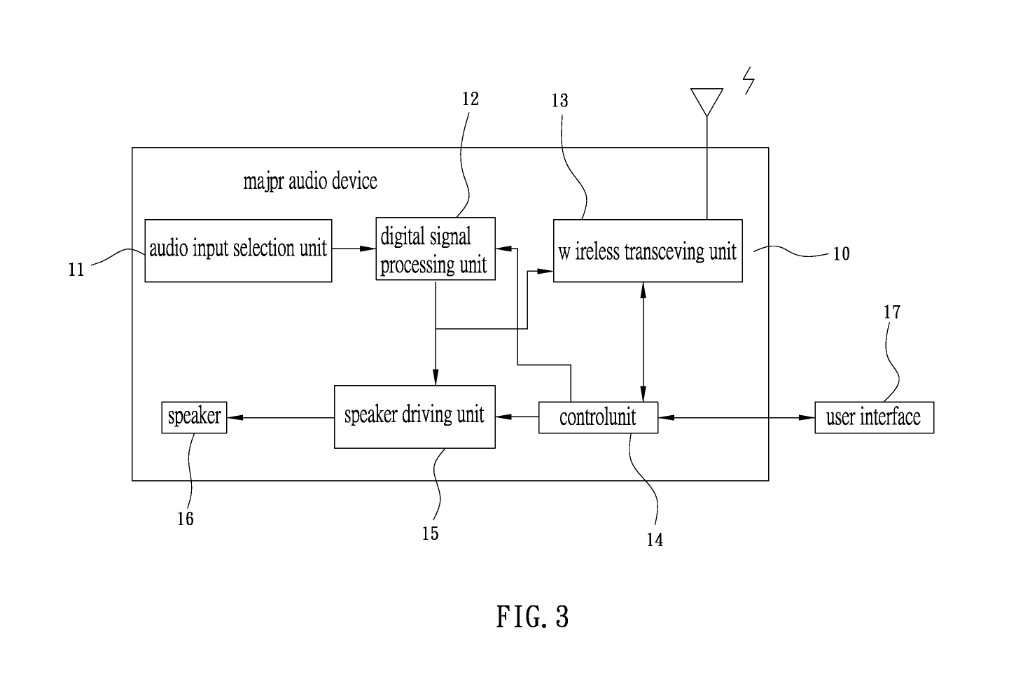

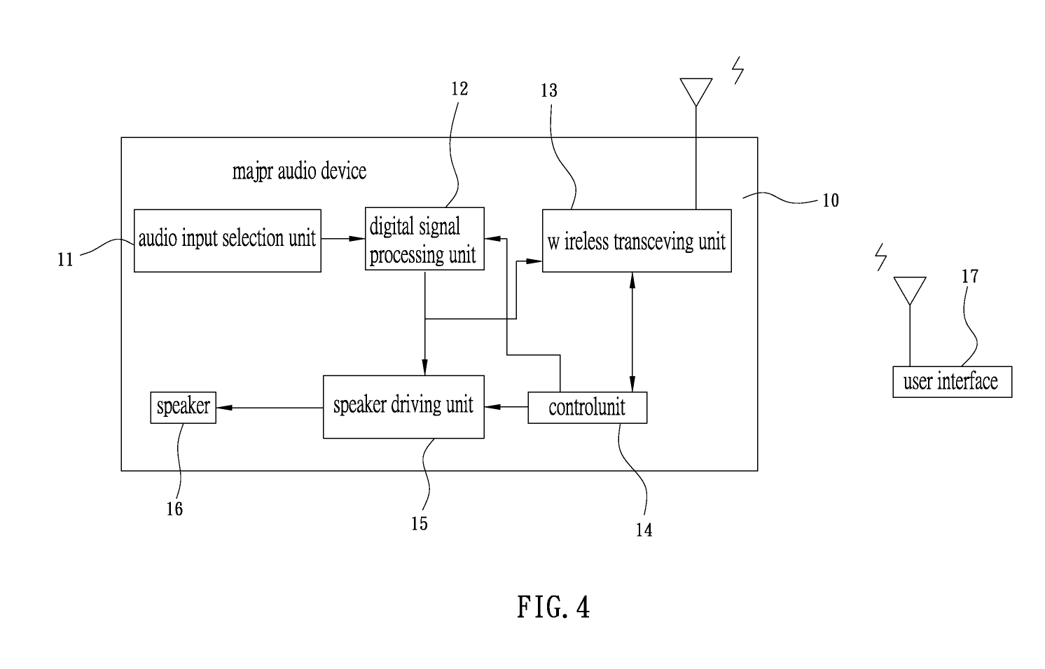

Referring to FIGS. 3 to 4, the major audio device 10 further includes an user interface 17 for displaying or inputting information. As shown in FIG. 3, the user interface 17 is electrically connected to the control unit 14 in a wired link, while the user interface 17 as shown in FIG. 4 is connected to the wireless transceving unit 13 in a wireless way. Therefore, the user interface 17 can be independent to the major audio device 10, or integrates to be installed on the outer surface of the major audio device 10, or can even be a remote control which can be operated by pressing button, touch pad, voice control, mouse, keyboard, knob, motion control (such as gesture control), etc.

Referring to FIG. 2, the wireless audio device 20 includes a first wireless transceving unit 21, a first control unit 22, a first speaker driving unit 23, and a first speaker 24. The first wireless transceving unit 21 receives a wireless signal sent from the major audio device 10. After being processed and calculated by the first control unit 22, the wireless signal can inform the first speaker driving unit 23 to drive the first speaker 24 for outputting sound.

As shown in FIG. 1, the audio system of the preferred embodiment has a wireless audio devices 20, but can also have more than one audio device 20 as well.

Referring to FIGS. 1 to 2, the wireless headset device 30 includes a second wireless transceving unit 31, a second control unit 32, a second speaker driving unit 33, and a second speaker 34.

The aforementioned second wireless transceving unit 31 receives the wireless signal sent from the major audio device 10. After being processed and calculated by the second control unit 32, the wireless signal informs the second speaker driving unit 33 to drive the second speaker 34 for outputting sound.

Referring to FIG. 2, the wireless headset device 30 further includes an user interface 35 for inputting information, such as turning on the wireless headset device 30. In the present embodiment, the user interface 35 is used for inputting information, such as panel, button, or switch, etc.

In the FIGS. 1 and 2, the audio system of the present embodiment is equipped with a wireless headset 30. Practically, more than one wireless headset 30 is also acceptable.

Referring to all the FIGS. in the present embodiment, when connecting the audio input 40 to the major audio device 10 under normal audio mode, the control unit 14 can order the digital signal processing unit 12 to use audio algorithm for providing audio mode. Meanwhile, the speaker driving unit 15 is forced to drive the speaker 16 to output sound, and the wireless transceving unit 13 sends out a wireless signal which is then received by the first wireless transceving unit 21 of the wireless audio device 20 and processed by the first control unit 22. After that, the first speaker driving unit 23 drives the first speaker 24 to output sound.

When the wireless headset device 30 is turned on (operated through the user interface 35), a signal will be sent to the major audio device 10 for turning off the sound output of the speaker of the major audio device 10 and the first speaker 24 of the wireless audio device 20, thus entering a mute mode.

For the detail procedure, when the headset device 30 is turned on, a signal will be sent to the second control unit 32. After being processed by the second control unit 32, the second wireless transceving unit 31 sends out the signal to the major audio device 10. The wireless transceving unit 13 of the major audio device 10 receives the signal. The signal is processed by the control unit 14, and the speaker driving unit 15 is informed to stop the sound output from the speaker 16. The wireless transceving unit 13 sends out mute order signal to the wireless audio device 20. The wireless audio device 20 receives the mute order signal via the first wireless transceving unit 21, and the first control unit 22 processes the signal to turn off the sound output from the first speaker 24. As mentioned above, after the wireless transceving unit 13 of the major audio device 10 receives the turn-on signal of the wireless headset device 30, the control unit 14 will inform the digital signal processing unit 12 to alter the audio signal processing method to wireless headset mode, thereby improving the sound quality.

As mentioned above, when the wireless headset 30 is turned off, the second control unit 32 orders the second wireless transceving unit 31 to send out the corresponding signal to the major audio device 10. After the wireless transceving unit 13 of the major audio device 10 receives the corresponding signal, the signal is processed by control unit 14 and then the digital signal processing unit 12 is informed to alter the audio signal processing method to audio mode. Meanwhile, the wireless transceving unit 13 informs the wireless audio device 20 to improve the sound quality of the audio device 10 and the wireless audio device 20.

When in use, users can operate (such as booting) the major audio device 10 and the wireless audio device 20 through the user interface 17, and set the audio system 100 to audio mode. When turning on the wireless headset device 30 (through the user interface 35), the audio system 100 automatically turns to wireless headset mode after the control unit 14 of the major audio device 10 being informed, and the major audio device 10 and the wireless audio device 20 are both being switched to a mute mode. Once the wireless headset 30 is turned off, the audio system 100 returns to audio mode.

It is noteworthy that, when there are more than one wireless headset 30 existed in the audio system 100, turning on any one of the wireless headset device 30 can make the audio system 100 enter headset mode; likewise, when there are more than one wireless audio device 20, all the wireless audio devices 20 will enter mute mode if any one of them is turned off. Once the mute mode is relieved, all the wireless audio devices 20 will be turned on to output the sound.

Since the wireless headset 30 in the present invention can allow the users free from the wire, and the wireless headset 30 can also share the audio source, the digital signal processing unit 12, and the wireless transceving unit 13 of the original wireless audio device 20, the installation procedure and structure can be simplified, thereby enhancing the convenience and minimizing the cost.

Although the present invention has been described with reference to the foregoing preferred embodiments, it will be understood that the invention is not limited to the details thereof Various equivalent variations and modifications can still occur to those skilled in this art in view of the teachings of the present invention. Thus, all such variations and equivalent modifications are also embraced within the scope of the invention as defined in the appended claims.

What is claimed is:

1. An audio system, comprising:
a major audio device including an audio input selection unit, a digital signal processing unit, a speaker driving unit, a wireless transceiving unit, a control unit and a speaker; the major audio device connecting all kinds of audio inputs, and an audio input selection unit selecting an audio signal thereof; the audio signal being processed by the digital signal processing unit and driving the speaker by the speaker driving unit; the selected audio signal being emitted to the air via the wireless transceiving unit; the control unit being responsible for calculating and processing the audio signal;
a wireless audio device including a first wireless transceving unit, a first control unit, a first speaker driving unit and a first speaker; the first wireless transceving unit receiving a wireless signal being emitted from the major audio device, and the wireless signal being provided to the first speaker driving unit for driving the first speaker; the first control unit being responsible for calculating and processing the wireless signal;
a wireless headset device including a second wireless transceving unit, a second speaker driving unit, a second control unit, and a second speaker; the second wireless transceving unit receiving a wireless signal being emitted from the major audio device, and the wireless signal being provided to the second speaker driving unit for driving the second speaker; the second control unit being responsible for calculating and processing the wireless signal;
wherein, a notification signal will be sent to the major audio device to turn off the sound output of the speaker of the major audio device and the first speaker of the wireless audio device when the wireless headset device is turned on.

2. The audio system according to claim 1, wherein when the wireless headset is turned on, a signal processed by the second control unit is sent to the major audio device by the second wireless transceving unit, and after the wireless transceving unit of the major audio device receiving the signal, the control unit drives the speaker driving unit to turn off sound output;
the wireless transceving unit sending out a mute signal to the wireless audio device, and after the wireless audio device receiving the mute signal via the first wireless transceiving unit, the first speaker being turned off under the control of the first controlling unit.

3. The audio system according to claim 1, wherein after the wireless transceving unit of the major audio system receiving a turn-on signal of the wireless headset device, the control unit can order the digital signal processing unit to change the processing method of the sound signal to wireless headset mode, thereby improving the outputted sound quality of the headset device.

4. The audio system according to claim 3, wherein the headset mode uses a wireless headset algorithm.

5. The audio system according to claim 1, wherein when the wireless headset device is turned off, the second control unit orders the second wireless transceving unit to send a corresponding signal to the major audio device; after the wireless transceving unit of the major audio device receiving the signal, the control unit processing the signal and informing the digital signal processing unit to change the sound signal processing method to audio mode, and further informing the wireless audio device via the wireless transceving unit to improve the outputted sound quality of the audio device and the wireless audio device.

6. The audio system according to the claim 1, wherein the major audio device further includes an user interface for displaying and inputting information.

7. The audio system according to the claim 1, wherein the wireless headset device further includes a user interface for inputting information.
